(19) United States
(12) Patent Application Publication
(10) Pub. No.: US 2015/0185831 A1
(43) Pub. Date: Jul. 2, 2015

(54) SWITCHING BETWEEN GAZE TRACKING AND HEAD TRACKING

(71) Applicants: Dinu Petre Madau, Canton, MI (US); Paul O. Morris, Ann Arbor, MI (US)

(72) Inventors: Dinu Petre Madau, Canton, MI (US); Paul O. Morris, Ann Arbor, MI (US)

(21) Appl. No.: 14/560,786

(22) Filed: Dec. 4, 2014

Related U.S. Application Data
(60) Provisional application No. 61/921,012, filed on Dec. 26, 2013.

(51) Int. Cl. G06F 3/01; G06F 3/00

(52) U.S. Cl. CPC G06F 3/012; G06F 3/013; G06F 3/005

(57) ABSTRACT

A system and method for switching between eye tracking and head tracking is provided herein. The system includes an eye tracking interfacer to interface with an eye tracking system; a head tracking interfacer to interface with a head tracking system; and a switching determiner to determine at least one of the eye tracking system and the head tracking system to control an electronic system. Also disclosed herein is an electronic system controlled by a eye tracking input device or a head tracking input device.

### CLAIM OF PRIORITY

This patent application claims priority to U.S. Provisional Application No. 61/921,012, filed Dec. 26, 2013, entitled “Switching Between Gaze Tracking and Head Tracking,” now pending. This patent application contains the entire Detailed Description of U.S. Patent Application No. 61/921,012.

### BACKGROUND

Electronic systems are controlled via an interface. An interface (or an input device) is essentially any sort of technique that allows a user to engage with the electronic system.

Conventionally, interfaces have been controlled by physical engagement (i.e. contact). For example, a user would engage an auxiliary device, such as a keyboard and mouse, and instruct a system via the interface through commands and movements facilitated through the device.

Additional types of interfaces have also been implemented. Touch screens or surfaces are now being implemented with various systems. The touch screens or surfaces allow a detected touch (for example, via a capacitive or resistive touch technology) to control the system associated with the interface.

In recent times, interfaces implementing voice activation as well as gesture based inputs have been realized. Both of these interfaces do not explicitly require physical engagement with an actual surface or device.

Another non-physical (or non-contact) interface type is eye tracking. Eye tracking employs an image or video capturing device, and the image or video capturing device captures the eye of the operator of the system. Accordingly, through digital signal processing, the eyes may be identified. Once the eyes are identified, various eye movements may be correlated with specific actions. For example, if the user blinks one time (or a predetermined amount of times), the system may be instigated to perform a certain action. In another instance, if the eyes move from one location to another, the system may be instigated to perform a certain action based on the movement.

Another non-physical interface is head tracking. Much like eye tracking, an image or video capturing device may be configured to capture an image or video of the user's head. Accordingly, various actions by the user's head may be correlated to system functions.

Due to the implementation of non-physical interface technology, such as those described above, various systems may provide an enhanced and safer user experience. For example, if these interfaces are implemented in a vehicular control system (for example, those systems associated with a dashboard/heads-up display of a vehicle), the operation of the vehicle may be made safer due to the fact that the operator of the vehicle does not need to move their hands to control a system.

### DESCRIPTION OF THE DRAWINGS

The detailed description refers to the following drawings, in which like numerals refer to like items, and in which:

FIG. 1 is a block diagram illustrating an example computer.

FIG. 2 is an example of a system for switching between eye tracking and head tracking.

FIG. 3 is an example of a method for switching between eye tracking and head tracking.

FIGS. 4(a) and (b) illustrate an example implementation of the system illustrated in FIG. 2.

FIG. 5 illustrates an example of an electronic system 290 configured to interact with a system 200 as described above.

### DETAILED DESCRIPTION

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience.

Non-physical interfaces, such as eye tracking and head tracking, provide a technique for a user to engage an interface without making physical contact with a surface. For example, if a user is a driver of a vehicle, the user does not have to take their hands off a steering wheel to engage an interface. Additionally, these interfaces provide alternate and additional ways to engage a system.

However, in certain cases, one input technique may not be very efficient at a specific moment or period of time. For example, a user may be wearing glasses that obstruct an ability to detect the user's eyes. In another case, the user may be looking in a direction that does not allow an image or video capturing device to effectively identify the eyes. In these cases, employing an eye tracking interface may be frustrated.

Disclosed herein are methods and systems for switching between eye tracking and head tracking. By allowing an interface to switch between eye tracking and head tracking, the interface becomes more dynamic and efficient. Thus, certain times when the user's eyes are not ideal for controlling a system, the aspects disclosed herein allow an alternate way to control the system. In the examples disclosed below, the concepts describe switching between eye tracking to head tracking; however, one of ordinary skill in the art may apply the concepts to switching between head tracking to eye tracking, or eye/head tracking to another input methodology.

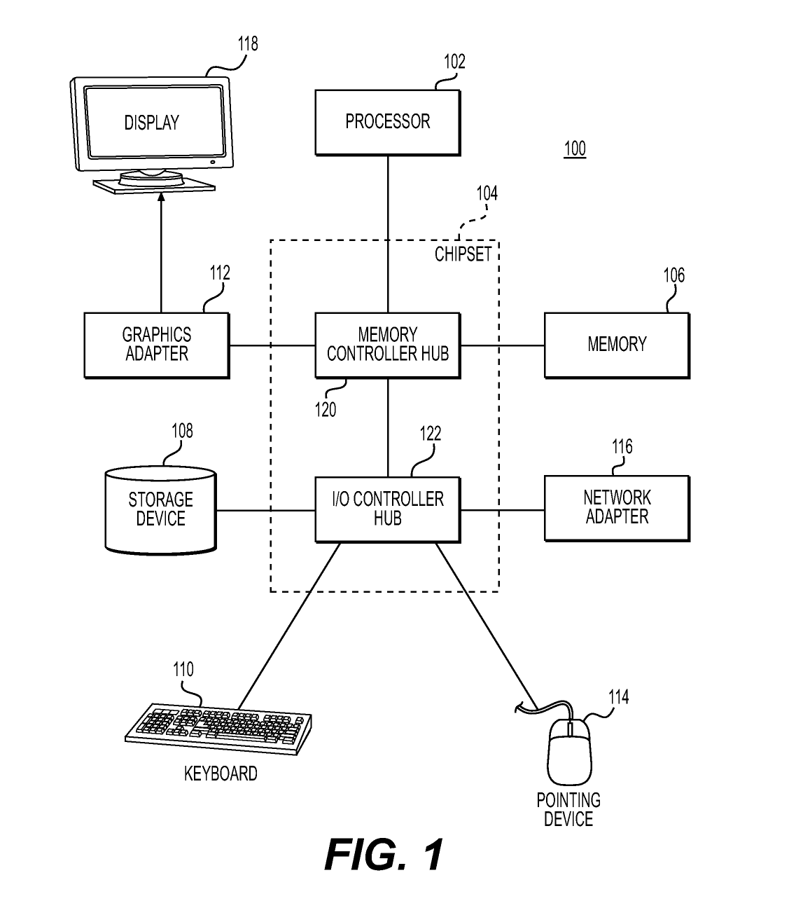

FIG. 1 is a block diagram illustrating an example computer 100. The computer 100 includes at least one processor 102 coupled to a chipset 104. The chipset 104 includes a memory controller hub 120 and an input/output (I/O) controller hub 122. A memory 106 and a graphics adapter 112 are coupled to the memory controller hub 120, and a display 118 is coupled to the graphics adapter 112. A storage device 108, keyboard 110, pointing device 114, and network adapter 116 are coupled to the I/O controller hub 122. Other embodiments of the computer 100 may have different architectures.

The storage device 108 is a non-transitory computer-readable storage medium such as a hard drive, compact disk read-only memory (CD-ROM), DVD, or a solid-state memory device. The memory 106 holds instructions and data used by the processor 102. The pointing device 114 is a mouse, track ball, or other type of pointing device, and is used in combination with the keyboard 110 to input data into the computer 100. The pointing device 114 may also be a gaming system controller, or any type of device used to control the gaming system. For example, the pointing device 114 may be connected to a video or image capturing device that employs biometric scanning to detect a specific user. The specific user may employ motion or gestures to command the point device 114 to control various aspects of the computer 100.

The graphics adapter 112 displays images and other information on the display 118. The network adapter 116 couples the computer system 100 to one or more computer networks.

The computer 100 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 108, loaded into the memory 106, and executed by the processor 102.

The types of computers used by the entities and processes disclosed herein can vary depending upon the embodiment and the processing power required by the entity. The computer 100 may be a mobile device, tablet, smartphone or any sort of computing element with the above-listed elements. For example, a data storage device, such as a hard disk, solid state memory or storage device, might be stored in a distributed database system comprising multiple blade servers working together to provide the functionality described herein. The computers can lack some of the components described above, such as keyboards 110, graphics adapters 112, and displays 118.

The computer 100 may act as a server (not shown) for the content sharing service disclosed herein. The computer 100 may be clustered with other computer 100 devices to create the server.

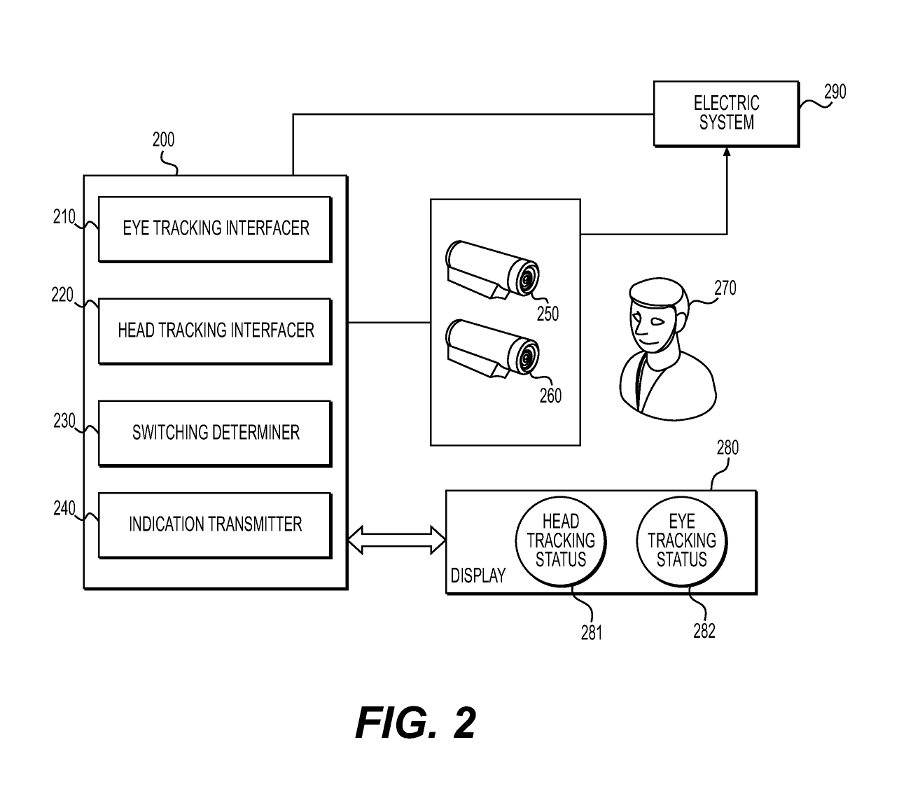

FIG. 2 is an example of a system 200 for switching between eye tracking 250 and head tracking 260. The system 200 includes an eye tracker interfacer 210, a head tracking interfacer 220, a switching determiner 230, and optionally, an indicator transmitter 240. The system 200 may be implemented on a device, such as computer 100.

The system 200 may be implemented in a vehicle, for example, with an image or video capturing device being provided for both the eye tracking 250 and head tracking 260. Alternatively (not shown), the image or video capturing device may be integrally provided for both tracking devices, or implemented with the same image or video capturing device. The various image or video capturing devices may be situated based on an implementer or user's preference, and adjusted to capture the user's eyes or head in an optimal way. Although not shown, the image and video capturing devices, and eye tracking 250 and head tracking 260 may be implemented with digital signal processing (DSP) modules that allow for the detection of the appropriate body part (i.e. the eyes or a head).

The eye tracking interfacer 210 interfaces with the eye tracking 250. The image or video capturing device associated with the eye tracking 250 communicates the data associated with the eye tracking 250 to the eye tracking interfacer 210. Accordingly, the various movements by the eyes (on a user 270) may be translated into commands.

The eye tracking interfacer 210 may control a system through observed actions via the user's eye. Thus, if system 200 is coupled to a turn signal, a blink of an eye once might correspond to turning on the turn signal.

The eye tracking interfacer 210 is configurable to be enabled or disabled. A user or operator of the system 200 may enable or disable the eye tracking interfacer 210 manually. Alternatively, the eye tracking interfacer 210 may be enabled or disabled via an automatic signal received by the system 200. The eye tracking interfacer 210 may also be enabled or disabled by the switching determiner 230, which will be described in greater detail below.

The head tracking interfacer 220 operates in the same way as the eye tracking interfacer 210, with the main difference being that the head tracking interfacer 210 interfaces with the head tracking 260 (which is focused on a user 270's head). Accordingly, all the ways configured to enable or disable eye tracking 250 may be analogous and similar to enabling and disabling head tracking 260.

The switching determiner 230 determines which interface (or interfaces) to optimally provide to the user. The switching determiner 230 may analyze the strength of each respective signal (i.e. the images from the eye tracking 250 and the head tracking 260). If the image clarity and strength is over a predetermined threshold (which may be individually assigned for each tracking), the switching determiner 230 determines to turn the respective interface on.

In certain cases, the switching determiner 230 may determine to employ the strongest signal (i.e. either eye tracking 250 or head tracking 260). In other situations, the switching determiner 230 may prioritize one over the other, and thus, if both are at a sufficiently strong level, the switching determiner 230 may default to selecting the tracking that is configured with the highest priority.

Further, the switching determiner 230 may determine to enable both (or disable both if the signal is too weak from both). Thus, a user may employ both eye tracking 250 and head tracking 260 to control a system.

The indicator transmitter 240 communicates an indication to a display to indicate which interfaces are on. The display may be, for example, a display integrated in or around a dashboard or heads-up display of a vehicle. The display may simply be an indication light (such as a light emitting diode) installed in an area where the user may observe such a light. By providing an indication, a user may be cognizant of the interfaces that are currently operational in real-time.

The display 280 shows an example of an indication technique according to system 200. The display 280 has two indicia, head tracking status 281 and eye tracking status 282. Thus, the display 280 may be configured to light either indicia based on the indication provided by system 200.

The indicator transmitter 240 may also communicate to an electronic system 290 associated with an input performed by either eye tracker 250 or the head tracker 260. Thus, the electronic system 290 may be configured to employ the eye tracker 250, the head tracker 260, both, or neither based on the determination performed by system 200. A more detailed explanation of the electronic system 290 is described below.

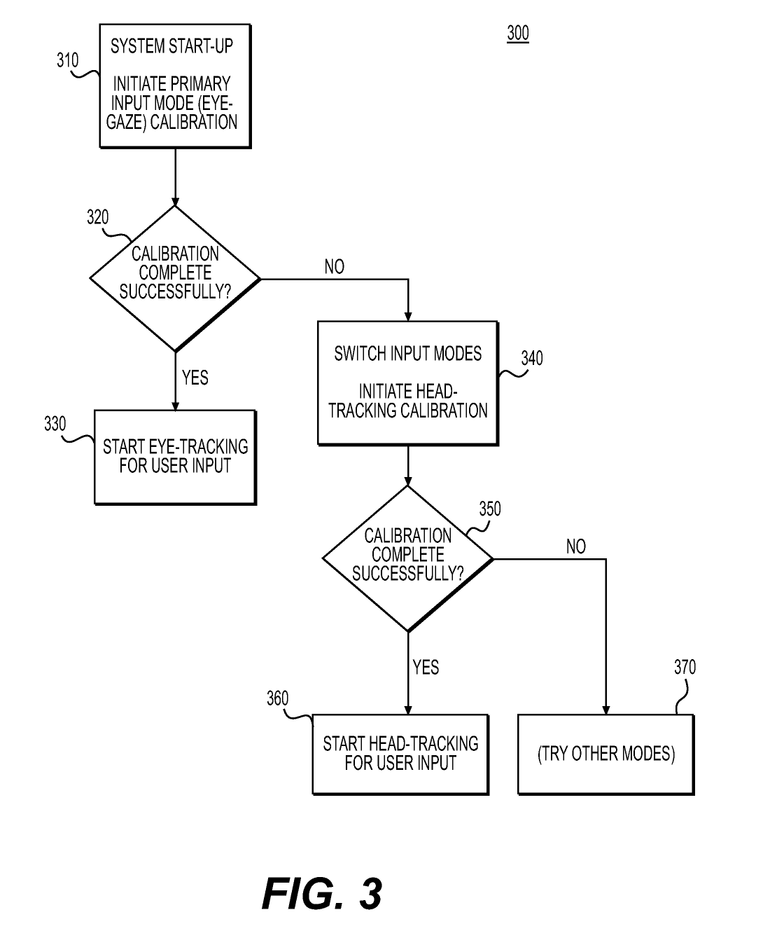

FIG. 3 illustrates a method 300 for switching between eye tracking and head tracking. The method 300 may be implemented on a computer 100.

In operation 310, a system startup occurs, and a primary interface mode is established. As shown in FIG. 3, the primary interface is established as eye tracking at startup. In an alternate example, the primary interface may be established to be head tracking, or another interface. The primary interface mode may be configurable by a user.

In operation 320, a determination as to whether a calibration associated with the primary interface established in operation 310 is made. Thus, the calibration determines whether a signal or setup associated with the interface mode is over a predetermined threshold. If yes, the method 300 maintains the current mode and proceeds to operation 330. If no, the method 300 proceeds to operation 340.

In operation 330, the primary interface established was eye tracking. Accordingly, the interface is maintained as eye tracking. Conversely, in operation 340, the primary interface is switched to a determination for a second mode. In the case of the example described in FIG. 3, the second mode is head tracking.

In operation 350, a determination is made as to whether the head tracking signal strength is over a predetermined threshold. If yes, the method 300 proceeds to operation 360, where head tracking is establish. If no, the method 300 proceeds to operation 370, where a default interface is employed. The default interface may be any sort of interface employed when the eye tracking and head tracking are not available.

The operations described above may be performed iteratively, with the iterations being set at a predetermined interval (by an implementer of method 300 or a user). Alternatively, various other triggers, such as detecting motion change and the like may be used as a way to instigate method 300 to perform a determination.

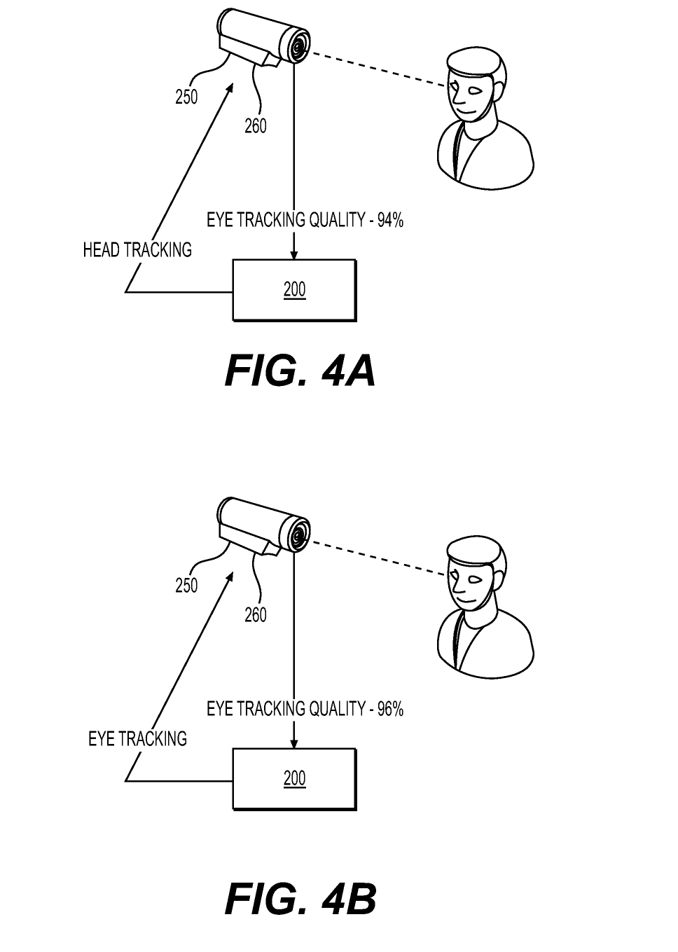

FIGS. 4(a) and (b) illustrate an example implementation of the system 200. As shown in in FIG. 4(a), a user 270 is situated in a location where an eye tracker 250 and a head tracker 260 are located (they are shown as one device for explanatory purposes, however, the two types of tracking may be implemented with other combinations and permutations of devices).

The eye tracker 250 and the head tracker 270 communicate information to a system 200. Further, system 200 controls which one of the trackers is employed as an input device. For the purposes of explanation, a predetermined threshold is set at 95% (and thus, any eye tracking occurring a signal strength below 95% causes the system to switch to head tracking).

Referring to FIG. 4(a), a signal strength associated with eye tracking is detected to be 94% (i.e. below 95%). Thus, in this situation, the system 200 couples the head tracker 260 to be a switched input device.

Referring to FIG. 4(b), a signal strength associated with head tracking is detected to be 96% (i.e. above 95%). Thus, in this situation, the system 200 couples the eye tracker 250 to be the switched input device.

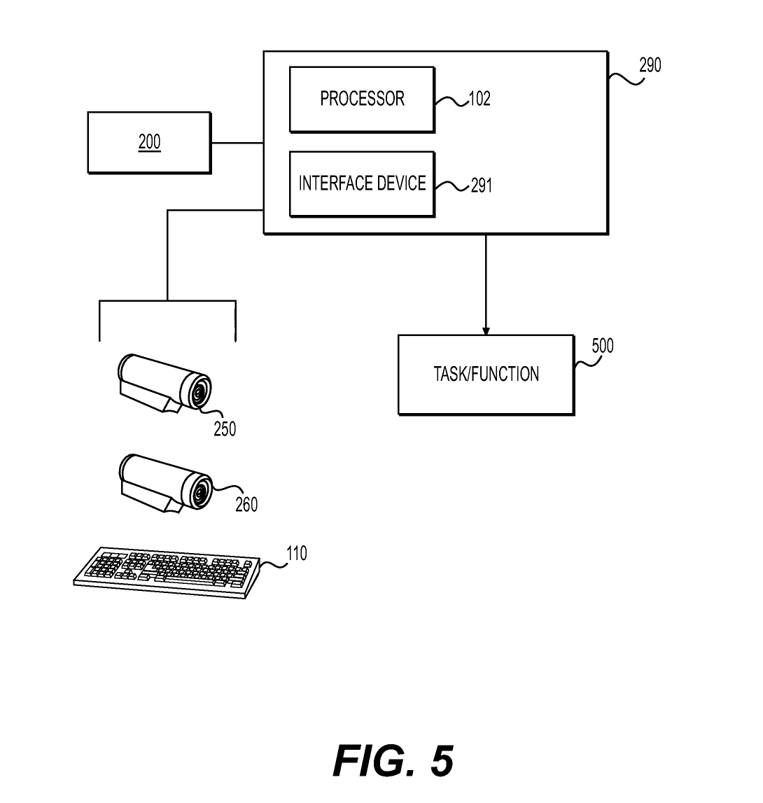

FIG. 5 illustrates an example of an electronic system 290 configured to interact with a system 200 as described above. The electronic system 290 is electrically coupled with a system 200, an eye tracker 250, and a head tracker 260. The electronic system 290 includes a processor 102 and an interface device 291.

The processor 102 may be configured to perform any task or function 500 that may employ an input device, such as a head tracker 250 or a gaze tracker 260. For example, a vehicle may implement both trackers, and provide a driver/passenger an opportunity to control a variety of vehicle related functions via the eye tracker 250, the head tracker 260, or both.

The interface device 291 may get an indication from the system 200 to couple the electronic system 290 with an input device. Once the interface device 291 receives an indication of which input device to employ, the interface device 291 may couple the selected input device (i.e. the eye tracker 250, or the head tracker 260) to the electronic system 290.

Certain of the devices shown in FIG. 1 include a computing system. The computing system includes a processor (CPU) and a system bus that couples various system components including a system memory such as read only memory (ROM) and random access memory (RAM), to the processor. Other system memory may be available for use as well. The computing system may include more than one processor or a group or cluster of computing system networked together to provide greater processing capability. The system bus may be any of several types of bus structures including a memory bus or memory controller, a peripheral bus, and a local bus using any of a variety of bus architectures. A basic input/output (BIOS) stored in the ROM or the like, may provide basic routines that help to transfer information between elements within the computing system, such as during start-up. The computing system further includes data stores, which maintain a database according to known database management systems. The data stores may be embodied in many forms, such as a hard disk drive, a magnetic disk drive, an optical disk drive, tape drive, or another type of computer readable media which can store data that are accessible by the processor, such as magnetic cassettes, flash memory cards, digital versatile disks, cartridges, random access memories (RAMs) and, read only memory (ROM). The data stores may be connected to the system bus by a drive interface. The data stores provide nonvolatile storage of computer readable instructions, data structures, program modules and other data for the computing system.

To enable human (and in some instances, machine) user interaction, the computing system may include an input device, such as a microphone for speech and audio, a touch sensitive screen for gesture or graphical input, keyboard, mouse, motion input, and so forth. An output device can include one or more of a number of output mechanisms. In some instances, multimodal systems enable a user to provide multiple types of input to communicate with the computing system. A communications interface generally enables the computing device system to communicate with one or more other computing devices using various communication and network protocols.

The preceding disclosure refers to a number of flow charts and accompanying descriptions to illustrate the embodiments represented in FIG. 3. The disclosed devices, components, and systems contemplate using or implementing any suitable technique for performing the steps illustrated in these figures. Thus, FIG. 3 is for illustration purposes only and the described or similar steps may be performed at any appropriate time, including concurrently, individually, or in combination. In addition, many of the steps in these flow charts may take place simultaneously and/or in different orders than as shown and described. Moreover, the disclosed systems may use processes and methods with additional, fewer, and/or different steps.

Embodiments disclosed herein can be implemented in digital electronic circuitry, or in computer software, firmware, or hardware, including the herein disclosed structures and their equivalents. Some embodiments can be implemented as one or more computer programs, i.e., one or more modules of computer program instructions, encoded on a tangible computer storage medium for execution by one or more processors. A computer storage medium can be, or can be included in, a computer-readable storage device, a computer-readable storage substrate, or a random or serial access memory. The computer storage medium can also be, or can be included in, one or more separate tangible components or media such as multiple CDs, disks, or other storage devices. The computer storage medium does not include a transitory signal.

As used herein, the term processor encompasses all kinds of apparatus, devices, and machines for processing data, including by way of example a programmable processor, a computer, a system on a chip, or multiple ones, or combinations, of the foregoing. The processor can include special purpose logic circuitry, e.g., an FPGA (field programmable gate array) or an ASIC (application-specific integrated circuit). The processor also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, module, engine, software, software application, script, or code) can be written in any form of programming language, including compiled or interpreted languages, declarative or procedural languages, and the program can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

To provide for interaction with an individual, the herein disclosed embodiments can be implemented using an interactive display, such as a graphical user interface (GUI). Such GUI's may include interactive features such as pop-up or pull-down menus or lists, selection tabs, scannable features, and other features that can receive human inputs.

The computing system disclosed herein can include clients and servers. A client and server are generally remote from each other and typically interact through a communications network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

We claim:

1. A system for switching between eye tracking and head tracking, comprising:
an eye tracking interfacer to interface with an eye tracking system;
a head tracking interfacer to interface with a head tracking system; and
a switching determiner to determine at least one of the eye tracking system and the head tracking system to control an electronic system.

2. The system according to claim 1, wherein switching determiner is configured to perform the determination by comparing a signal strength associated with the eye tracking system and a signal strength associated with the head tracking system.

3. The system according to claim 2, wherein in response to the signal strength of the eye tracking system being under a predetermined threshold, the switching determiner determines that the head tracking system controls the electronic system.

4. The system according to claim 2, wherein the greater of the signal strengths between the eye tracking system and the head tracking system is employed by the switching determiner to determine whether the head tracking system or the eye tracking system controls the electronic system.

5. They system according to claim 1, wherein the electronic system is installed in a vehicle.

6. The system according to claim 1, further comprising an indication transmitter to transmit the determination to a display.

7. The system according to claim 2, further comprising an indication transmitter to transmit the signal strengths to a display.

8. A method for switching between eye tracking and head tracking, comprising:
initiating a system in a primary mode, wherein the primary mode is one of the eye tracking, head tracking, or another interface;
determining whether a signal strength of the primary mode is above a predetermined threshold, and in response to the primary mode being above the predetermined threshold, establishing the primary mode as an interface to control an electronic system;
in response to the signal strength of the primary mode being below the predetermined threshold, establishing a secondary mode as an interface to control an electronic system, wherein the secondary mode differs from the primary mode.

9. The method according to claim 8, wherein the secondary mode is head tracking.

10. The method according to claim 9, further comprising:
determining whether a signal strength of the secondary mode is above a second predetermined threshold, and in response to the secondary mode being above the second predetermined threshold, establishing the secondary mode as the interface to control the electronic system;
in response to the signal strength of the secondary mode being below the second predetermined threshold, establishing a third mode as an interface to control the electronic system, wherein the third mode differs from the primary mode and the secondary mode.

11. The method according to claim 10, wherein the third mode is a physical user input device.

12. The method according to claim 10, wherein the electronic system is installed in a vehicle.

13. An electronic system controlled by an eye tracking input device or a head tracking input device, comprising:
a processor configured to perform a task; and
an interface device to facilitate a user in performing the task,
wherein the interface device is configured to couple to only one of the gaze tracking input device or the head tracking input device.
